(19) United States
(12) Patent Application Publication
(10) Pub. No.: US 2026/0221340 A1
(43) Pub. Date: Jul. 30, 2026

(54) MULTILAYER ELECTRONIC COMPONENT

(71) Applicant: SAMSUNG ELECTRO-MECHANICS CO., LTD., Suwon-si (KR)

(72) Inventors: Ji Young LEE, Suwon-si (KR); Sang Jong LEE, Suwon-si (KR); Dong Jun JUNG, Suwon-si (KR); Joon Yeob CHO, Suwon-si (KR); Da Hyun CHOI, Suwon-si (KR); Hyun Min LEE, Suwon-si (KR)

(73) Assignee: SAMSUNG ELECTRO-MECHANICS CO., LTD., Suwon-si (KR)

(21) Appl. No.: 19/410,578

(22) Filed: Dec. 5, 2025

(30) Foreign Application Priority Data
Jan. 24, 2025 (KR) 10-2025-0010899

(51) Int. Cl. H01G 4/12; H01G 4/30

(52) U.S. Cl. CPC H01G 4/12; H01G 4/30

(57) ABSTRACT

A multilayer electronic component includes a body including a dielectric layer and internal electrodes alternately disposed with the dielectric layer in a thickness direction, and an external electrode disposed on the body. A surface potential difference (ΔV) between one surface and the other surface of the dielectric layer opposing each other in the thickness direction, measured by a Kelvin probe force microscopy (KPFM), is 0.63 V or less.

### CROSS-REFERENCE TO RELATED APPLICATION(S)

This application claims benefit of priority to Korean Patent Application No. 10-2025-0010899 filed on Jan. 24, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as image display devices, including a liquid crystal display (LCD) and a plasma display panel (PDP), computers, smartphones, and mobile phones, and serves to charge or discharge electricity therein or therefrom. The MLCC may be used as a component of various electronic devices due to having a small size, ensuring high capacitance and being easily mounted.

As demand for small-sized MLCCs has recently increased, there is a growing requirement for thinning of dielectric layers. However, as the thickness of the dielectric layer decreases, an issue arises in that the dielectric layer has reduced insulation resistance. The insulation resistance of the dielectric layer may be a factor directly affecting reliability of an MLCC, and thus it may be necessary to resolve such an issue.

### SUMMARY

An aspect of the present disclosure is to provide a multilayer electronic component having excellent reliability.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and internal electrodes alternately disposed with the dielectric layer in a thickness direction, and an external electrode disposed on the body. A surface potential difference (ΔV) between a first surface and a second surface of the dielectric layer opposing each other in the thickness direction, as measured by a Kelvin probe force microscopy (KPFM), may be 0.63 V or less.

According to example embodiments of the present disclosure, a multilayer electronic component may have excellent reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic enlarged view of region “K1” of FIG. 2;

FIG. 5 is a schematic graph illustrating a surface potential in each position of a dielectric layer, measured by a Kelvin probe force microscopy (KPFM);

FIG. 6 is a schematic graph illustrating a differential graph obtained by first-order differentiating the graph of FIG. 5;

FIG. 7A is a KPFM surface potential map of a capacitance formation portion of Example 1;

FIG. 7B is a KPFM surface potential map of a capacitance formation portion of Comparative Example 1;

FIG. 8A is a graph illustrating results of a highly accelerated life test (HALT) of Example 1;

FIG. 8B is a graph illustrating results of a HALT of Comparative Example 1;

FIG. 9A is an electric field map of a capacitance formation portion of Example 1; and

FIG. 9B is an electric field map of a capacitance formation portion of Comparative Example 1.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a thickness (T) direction, a Y-direction may be defined as a length (L) direction, and a Z-direction may be defined as a width (W) direction.

### Multilayer Electronic Component

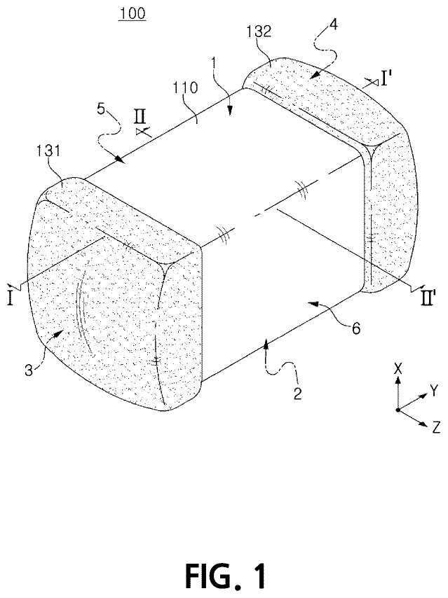

FIG. 1 is a schematic perspective view of a multilayer electronic component according to an example embodiment of the present disclosure.

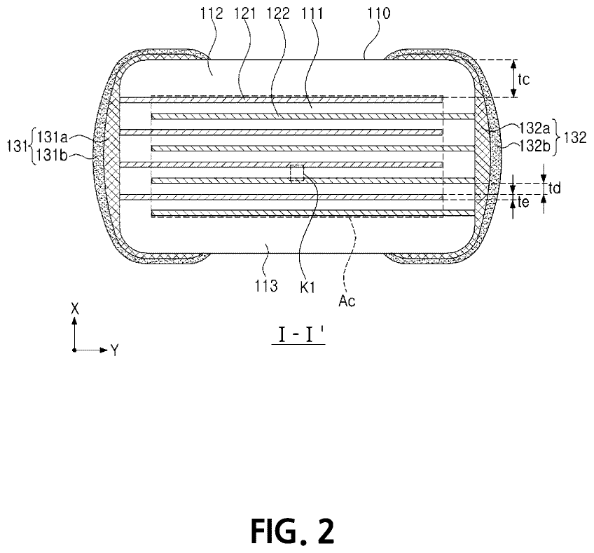

FIG. 2 is a schematic cross-sectional view taken along line I-I′ of FIG. 1.

FIG. 2 is a schematic cross-sectional view taken along line II-II′ of FIG. 1.

FIG. 4 is a schematic enlarged view of region “K1” of FIG. 2.

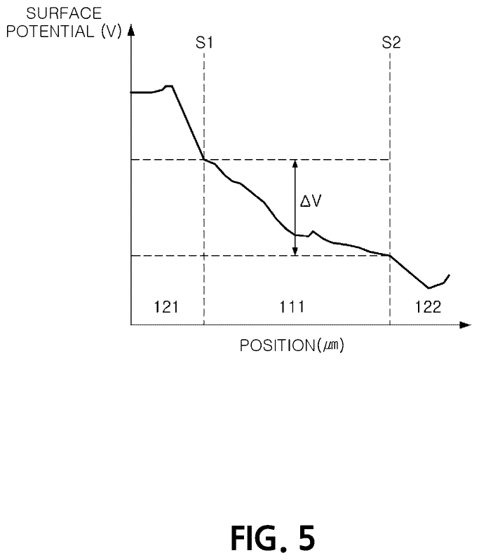

FIG. 5 is a schematic graph illustrating a surface potential in each position of a dielectric layer, measured by a Kelvin probe force microscopy (KPFM).

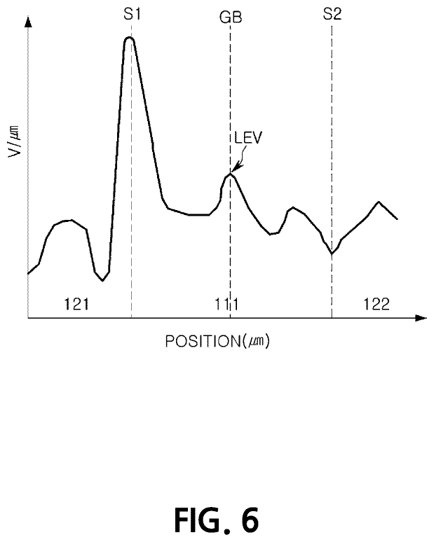

FIG. 6 is a schematic graph illustrating a differential graph obtained by first-order differentiating the graph of FIG. 5.

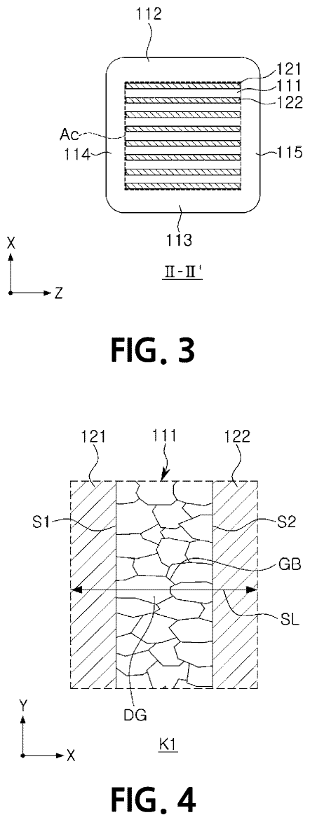

Hereinafter, a multilayer electronic component 100 according to an example embodiment of the present disclosure will be described in detail with reference to FIGS. 1 to 6. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A length of the multilayer electronic component 100 may be greater than each of a width and a thickness of the multilayer electronic component 100, but the present disclosure is not limited thereto. For example, the length of the multilayer electronic component 100 may be less than the width of the multilayer electronic component 100. The width of the multilayer electronic component 100 may be less than or greater than the thickness of the multilayer electronic component 100, and may vary depending on specifications or characteristics of the multilayer electronic component 100.

The multilayer electronic component 100 may include a body 110 including a dielectric layer 111 and internal electrodes 121 and 122, and external electrodes 131 and 132 disposed on the body 110.

A specific shape of the body 110 is not limited. However, as illustrated, the body 110 may have a hexahedral shape or a shape similar thereto. Due to shrinkage of ceramic powder included in the body 110 during a sintering process or polishing of corners, the body 110 may not have a hexahedral shape having perfectly straight lines, but may have a substantially hexahedral shape.

The body 110 may have first and second surfaces 1 and 2 opposing each other in the thickness direction, third and fourth surfaces 3 and 4 connected to the first and second surfaces 1 and 2, the third and fourth surfaces 3 and 4 opposing each other in the length direction, and fifth and sixth surfaces 5 and 6 connected to the first to fourth surfaces 1, 2, 3, and 4, the fifth and sixth surfaces 5 and 6 opposing each other in the width direction.

The body 110 may include a dielectric layer 111 and internal electrodes 121 and 122 alternately disposed with the dielectric layer 111 in the thickness direction. A plurality of dielectric layers 111, included in the body 110, may be in a sintered state, and adjacent dielectric layers 111 may be integrated with each other such that boundaries therebetween are not readily apparent without using a scanning electron microscope (SEM).

The internal electrodes 121 and 122 may include, for example, a first internal electrode 121 and a second internal electrode 122 alternately disposed with the dielectric layer 111 interposed therebetween. The body 110 may include a capacitance formation portion Ac in which the first internal electrode 121 and the second internal electrode 122 disposed to oppose each other with the dielectric layer 111 interposed therebetween to form capacitance.

The first internal electrode 121 may be spaced apart from the fourth surface 4, and may be connected to the first external electrode 131 on the third surface 3. The second internal electrode 122 may be spaced apart from the third surface 3, and may be connected to the second external electrode 132 on the fourth surface 4.

A conductive metal, included in the internal electrodes 121 and 122, may include one or more of Ni, Cu, Pd, Ag, Au, Pt, Sn, W, Ti, and alloys thereof, and may more preferably include Ni, but the present disclosure is not limited thereto.

The body 110 may include cover portions 112 and 113 disposed on both surfaces of the capacitance formation portion Ac opposing each other in the thickness direction, and margin portions 114 and 115 disposed on both surfaces of the capacitance formation portion Ac opposing each other in the width direction. The cover portions 112 and 113 and the margin portions 114 and 115 may have a configuration similar to that of the dielectric layer 111, except that an internal electrode is not included.

The external electrodes 131 and 132 may be disposed on the third and fourth surfaces 3 and 4. The external electrodes 131 and 132 may include a first external electrode 131 disposed on the third surface 3, the first external electrode 131 extending onto portions of the first, second, fifth, and sixth surfaces 1, 2, 5, and 6, and a second external electrode 132 disposed on the fourth surface 4, the second external electrode 132 extending onto portions of the first, second, fifth, and sixth surfaces 1, 2, 5, and 6.

A type or form of the external electrodes 131 and 132 is not limited, and may have a multilayer structure. For example, the external electrodes 131 and 132 may include base electrode layers 131a and 132a in contact with the internal electrodes 121 and 122, and plating layers 131b and 132b disposed on the base electrode layers 131a and 132a.

The base electrode layers 131a and 132a may include a sintered electrode layer including a metal and glass. The metal, included in the sintered electrode layer, may include, for example, Cu, Ni, Pd, Pt, Au, Ag, Pb, and/or an alloy including the same. The glass, included in the sintered electrode layer, may include, for example, one or more oxides of Ba, Ca, Zn, Al, B, and Si.

The base electrode layers 131a and 132a may include only the sintered electrode layer including a metal and glass, but the present disclosure is not limited thereto. The base electrode layers 131a and 132a may include, for example, a sintered electrode layer including a metal and glass, and a resin electrode layer disposed on the sintered electrode layer, the resin electrode layer including metal particles and resin.

The metal particles, included in the resin electrode layer, may include one or more of spherical particles and flake-type particles. The metal particles included in the resin electrode layer, may include, for example Cu, Ni, Pd, Pt, Au, Ag, Pb, Sn and/or an alloy including the same. The resin, included in the resin electrode layer, may include, for example, one or more of epoxy resin, acrylic resin, and ethyl cellulose.

The plating layers 131b and 132b may include, for example, Ni, Sn, Pd, and/or an alloy including the same, and may be formed of a plurality of layers. The plating layers 131b and 132b may be, for example, Ni plating layers or Sn plating layers, and may also be formed in a structure in which a Ni plating layer and a Sn plating layer are sequentially formed. The plating layers 131b and 132b may include a plurality of Ni plating layers and/or a plurality of Sn plating layers.

In the drawings, a structure is described in which the multilayer electronic component 100 has two external electrodes 131 and 132, but the present disclosure is not limited thereto, and the number or shape of the external electrodes 131 and 132 may be changed depending on the form of the internal electrodes 121 and 122 or other purposes.

The dielectric layer 111 may include, for example, a perovskite-type compound, represented by ABO₃, as a main ingredient. The perovskite-type compound, represented by ABO₃, may be, for example, one or more of BaTiO₃, (Ba₁₋ₓCaₓ)TiO₃ (0<x<1), Ba (Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5).

The dielectric layer 111 may include a plurality of dielectric grains DG, and a grain boundary GB disposed between adjacent dielectric grains DG.

Insulation resistance of the multilayer electronic component may be determined by various factors, such as resistance at an interface between the dielectric layer and the internal electrode, resistance of the grain boundary, and internal resistance of the dielectric grains. In particular, the resistance of the grain boundary may serve as a potential barrier hindering movement of electrons. However, when a high electric field is concentrated at the grain boundary, the insulation resistance of the multilayer electronic component 100 may degrade.

The present applicant has confirmed that when a high electric field is concentrated in a specific region of the dielectric layer such as the grain boundary, a surface potential, measured by the KPFM in the specific region, may abruptly change. That is, a low surface potential difference between one surface and the other surface of the dielectric layer, opposing each other in the thickness direction, may indicate that an electric field is uniformly distributed in the dielectric layer.

Accordingly, in the multilayer electronic component 100 according to an example embodiment of the present disclosure, a surface potential difference (ΔV) between one surface (e.g., first surface) S1 and the other surface (e.g., second surface) S2 of the dielectric layer 111 opposing each other in the thickness direction, measured by the KPFM, may be 0.63 V or less, which may mean that an electric field is uniformly distributed in the dielectric layer 111. Accordingly, insulation resistance of the dielectric layer 111 to be maintained at or above a certain level, thereby effectively improving reliability of the multilayer electronic component 100.

A lower limit of ΔV is not limited, it may be, for example, 0.5 V or more.

Surface potential measurement of the dielectric layer 111 by the KPFM may be performed, for example, on a cross-section (L-T cross-section) in the thickness direction and the length direction of a central portion in the width direction of the multilayer electronic component 100. Specifically, a surface potential map may be obtained by analyzing, using the KPFM, a central region in the thickness and length directions of the capacitance formation portion Ac in the L-T cross-section. Thereafter, a surface potential in each position of the dielectric layer 111 may be derived through a line profile obtained by line analysis of a region corresponding to the dielectric layer 111 in the surface potential map. For example, FIG. 5 may be derived from a line profile obtained by analyzing a surface potential of the dielectric layer 111 along a measurement line SL of FIG. 4, and the surface potential difference (ΔV) between one surface S1 and the other surface S2 of the dielectric layer 111, opposing each other in the thickness direction, may be calculated through the line profile. Other methods and/or tools appreciated by one of ordinary skill in the art, even if not described in the present disclosure, may also be used.

The one surface S1 and the other surface S2 of the dielectric layer 111 may be distinguished from each other in color and/or brightness differences in the surface potential map. For example, in the surface potential map, the first internal electrode 121 to which a positive voltage is applied may appear the brightest, and the second internal electrode 122 to which a negative voltage is applied may appear the darkest. A region disposed between the first internal electrode 121 and the second internal electrode 122 may be specified as the dielectric layer 111. Alternatively, as illustrated in FIG. 6, in a differential graph obtained by first-order differentiating a graph illustrating a surface potential in each position of the dielectric layer 111 measured by the KPFM, a local extreme point appearing in a region, adjacent to the first internal electrode 121 of the dielectric layer 111, may be specified as the one surface S1 of the dielectric layer 111, and a local extreme point appearing in a region, adjacent to the second internal electrode 122, may be specified as the other surface S2 of the dielectric layer 111. The differential graph may be obtained by software that can perform first-order differentiation, such as mathematical and scientific computing programs, e.g., MATLAB. Other methods and/or tools appreciated by one of ordinary skill in the art, even if not described in the present disclosure, may also be used.

The surface potential of the dielectric layer 111, measured by the KPFM, may gradually increase or gradually decrease from the one surface S1 to the other surface S2 of the dielectric layer 111. For example, FIG. 5 may be an example in which a positive voltage is applied to the first internal electrode 121 and a negative voltage is applied to the second internal electrode 122. In this case, the surface potential of the dielectric layer 111 may gradually decrease from the one surface S1 to the other surface S2. In the present disclosure, “gradually increase or decrease” may mean that, although the surface potential is constant, decreases, or increases in some sections among the entire region from the one surface S1 to the other surface S2, the surface potential tends to increase or decrease in most of the region, for example, in at least 90% of the region. The term “gradually” may indicate a difference in the surface potential of more than 0% and less than 10%, 5%, 3%, or 1% relative to the surface potential at the first surface.

Referring to FIG. 6, in an example embodiment, a differential graph obtained by first-order differentiating a graph illustrating a surface potential in each position of the dielectric layer 111, measured by the KPFM, may have at least one local extreme value LEV in a position corresponding to a central portion of the dielectric layer 111. Here, the central portion of the dielectric layer 111 may refer to a remaining region excluding regions adjacent to interfaces with the internal electrodes 121 and 122. That the differential graph has the local extreme value LEV in a specific position may mean that trend of a slope of the graph illustrating the surface potential in each position changes at the specific position.

For example, a differential graph obtained by first-order differentiating a graph illustrating a surface potential in each position of the dielectric layer 111, measured by the KPFM, may exhibit a local extreme value LEV in a position corresponding to the grain boundary GB. The grain boundary GB may correspond to a region having high resistance as compared to the interior of the dielectric grains DG. Accordingly, an increase or decrease in surface potential may occur in the grain boundary GB, as compared to the interior of the dielectric grains DG.

However, the multilayer electronic component 100 according to an example embodiment of the present disclosure may aim to design the dielectric layer 111 such that an electric field is uniformly distributed in the dielectric layer 111, thereby minimizing a resistance difference between the dielectric grains DG and the grain boundary GB. Accordingly, in an example embodiment, the local extreme value LEV in the differential graph may be 40 V/μm or less. A lower limit of the local extreme value LEV in the differential graph is not limited, and may be greater than 0.

The differential graph may have two or more, three or more, or four or more local extreme values in a position corresponding to the central portion of the dielectric layer 111. In this case, the local extreme value LEV may refer to a maximum value, among a plurality of local extreme values. The number of local extreme values in the differential graph may vary depending on the number of dielectric grains DG and grain boundaries GB present along the measurement line SL. In an example embodiment, two or more and three or less dielectric grains may be present in the dielectric layer 111 in the thickness direction. The number of dielectric grains may be determined by using an SEM or a transmission electron microscope (TEM). Other methods and/or tools appreciated by one of ordinary skill in the art, even if not described in the present disclosure, may also be used.

An average size of the dielectric grains DG is not limited, but may be, for example, 150 nm or more and 300 nm or less. The average size of the dielectric grains DG may be a value obtained by measuring sizes of dielectric grains observed in an image obtained by capturing a portion of the capacitance formation portion Ac in an L-T cross-section of a central portion in the width direction of the multilayer electronic component 100, using an SEM or a transmission electron microscope (TEM), and averaging the measured sizes of the dielectric grains. Other methods and/or tools appreciated by one of ordinary skill in the art, even if not described in the present disclosure, may also be used.

Hereinafter, sub-ingredients that may be included in the dielectric layer 111 will be described. Hereinafter, the sub-ingredients are described based on the number of moles of each element, and the number of moles of each element may be converted and calculated as an input amount of an oxide or carbonate of an additive before sintering. Unless otherwise specified, contents of an element before and after sintering may not differ significantly, and types and contents of elements included in the dielectric layer 111 may be measured using various measurement methods such as SEM-EDS, TEM-EDS, and STEM-EDS after sintering.

As an example of a more specific method of measuring the content of each element included in the dielectric layer 111, internal ingredients of dielectric grains in a central portion of the capacitance formation portion Ac may be analyzed using TEM-EDS or STEM-EDS. First, a thinned sample for analysis may be prepared from a region including the dielectric layer 111 of a cross-section of the sintered capacitance formation portion Ac using a focused ion beam (FIB) apparatus. Then, a damage layer on a surface of the thinned sample may be removed using Ar ion milling, and qualitative/quantitative analysis may be performed by mapping each ingredient in an image obtained through (S)TEM-EDS. In this case, a qualitative/quantitative analysis graph for each ingredient may be represented as weight percentage (wt %), atomic percentage (at %), or molar percentage (mol %).

### 1) First Sub-Ingredient

The dielectric layer 111 may further include a first sub-ingredient including at least one of Y, Dy, Tb, Sc, La, Nd, Eu, Gd, Ho, Er, Yb and Lu. The first sub-ingredient may serve to improve reliability of the multilayer electronic component 100.

A content of the first sub-ingredient, included in the dielectric layer 111, may be 2.5 moles or more and 10.0 moles or less relative to 100 moles of Ti. As a result, a dielectric constant at room temperature and/or insulation resistance characteristics may be improved.

### 2) Second Sub-Ingredient

The dielectric layer 111 may include one or more of a fixed-valence acceptor element and a variable-valence acceptor element. Here, the fixed-valence acceptor element may include one or more of Mg and Zr, and the variable-valence acceptor element may include one or more of Mn, V, Cr, Fe, Ni, Co, Cu, and Zn. That is, the dielectric layer 111 may further include a second sub-ingredient including one or more of Mg, Zr, Mn, V, Cr, Fe, Ni, Co, and Zn.

The variable-valence acceptor element and the fixed-valence acceptor element may serve to reduce electron concentration, and may serve to lower sintering temperature and improve high-temperature withstand voltage characteristics of the multilayer electronic component. A content of the second sub-ingredient included in the dielectric layer 111 may be, for example, 0.01 mol or more and 8.0 mol or less relative to 100 mol of Ti.

### 3) Third Sub-Ingredient

The dielectric layer 111 may further include a third sub-ingredient including one or more of Si and Al. The third sub-ingredient may serve to improve sintering density, thereby improving a dielectric constant and DC-bias characteristics.

A content of the third sub-ingredient, included in the dielectric layer 111, may be, for example, 1.0 mol or more and 5.0 mol or less relative to 100 mol of Ti.

A size of the multilayer electronic component 100 is not limited, but the multilayer electronic component 100 may have a length of 0.1 mm to 6.0 mm, a width of 0.1 mm to 5.0 mm, and a thickness of 0.05 mm to 3.5 mm.

An average thickness (td) of the dielectric layer 111 is not limited, but may be, for example, 0.01 μm to 10 μm. An average thickness (te) of each of the internal electrodes 121 and 122 is not limited, but may be, for example, 0.01 μm to 3 μm or less.

In addition, the average thickness (td) of the dielectric layer 111 and the average thickness (te) of each of the internal electrodes 121 and 122 may be arbitrarily set depending on desired characteristics or applications. For example, for small-sized IT electronic components, to achieve miniaturization and high capacitance, the average thickness (td) of the dielectric layer 111 may be 0.4 μm or less, and the average thickness (te) of each of the internal electrodes 121 and 122 may be 0.4 μm or less.

Generally, as the dielectric layer 111 and the internal electrodes 121 and 122 have a reduced thickness, degradation in insulation resistance may easily occur, causing a reduction in reliability of the multilayer electronic component. However, in an example embodiment of the present disclosure, even when the average thickness (td) of the dielectric layer 111 is 0.4 μm or less and/or the average thickness (te) of each of the internal electrodes 121 and 122 is 0.4 μm or less, reliability of the multilayer electronic component 100 may be ensured.

The average thickness (td) of the dielectric layer 111 and the average thickness (te) of each of the internal electrodes 121 and 122 may be measured, for example, by scanning, using an SEM, a cross-section of the body 110 in the thickness and length directions at a magnification of 10,000. More specifically, the average thickness (td) of the dielectric layer 111 may be measured by measuring thicknesses of a single dielectric layer 111 at multiple points of the dielectric layer 111, for example, five points spaced apart from each other at equal intervals in the length direction, and calculating an average value of the thicknesses. In addition, the average thickness (te) of each of the internal electrodes 121 and 122 may be measured by measuring thicknesses of a single internal electrode 121 or 122 at multiple points of the internal electrode 121 or 122, for example, five points spaced apart from each other at equal intervals in the length direction, and calculating an average value of the thicknesses. The five points, spaced apart from each other at equal intervals, may be designated in the capacitance formation portion Ac. When such average value measurement is performed on ten dielectric layers 111 and ten internal electrodes 121 and 122, the average thickness (td) of the dielectric layer 111 and the average thickness (td) of each of the internal electrodes 121 and 122 may be further generalized. Other methods and/or tools appreciated by one of ordinary skill in the art, even if not described in the present disclosure, may also be used.

An average thickness (tc) of each of the cover portions 112 and 113 is not limited. The average thickness (tc) of each of the cover portions 112 and 113 may be, for example, 5 μm or more and 100 μm or less. For example, when the multilayer electronic component 100 has a size of 1005 (length: about 1.0 mm, width: about 0.5 mm) or less, the average thickness (tc) of each of the cover portions 112 and 113 may be 5 μm or more and 35 μm or less. Here, the average thickness (tc) of each of the cover portions 112 and 113 may refer to an average thickness of each of a first cover portion 112 and a second cover portion 113. The average thickness (tc) of each of the cover portions 112 and 113 may refer to a value obtained by averaging thicknesses measured at five points, spaced apart from each other at equal intervals, in a cross-section in the thickness direction and the length direction of the multilayer electronic component 100.

Hereinafter, an example of a method of forming the multilayer electronic component 100 will be described. However, a method of manufacturing the multilayer electronic component 100 is not limited thereto.

First, ceramic powder particles for forming a dielectric layer 111 may be prepared. The ceramic powder particles may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). An average particle diameter of the ceramic powder particles may be, for example, 50 nm or more and 300 nm or less, or 100 nm or more and 200 nm or less. BaTiO₃ powder particles may be synthesized, for example, by reacting a titanium raw material such as titanium dioxide and a barium raw material such as barium carbonate. A synthesis method of the ceramic powder particles may include, for example, a solid-state method, a sol-gel method, or a hydrothermal synthesis method, but the present disclosure is not limited thereto.

Subsequently, the prepared ceramic powder particles may be dried and pulverized, and then mixed with first to third sub-ingredient powder particles, an organic solvent such as ethanol, and a dispersant to prepare a slurry, and milled for 1 hour to 30 hours. Thereafter, a binder such as polyvinyl butyral may be mixed into the slurry and further milled for 1 hour to 15 hours. The thus-prepared slurry may be coated and dried on a carrier film to prepare a ceramic green sheet.

Subsequently, an internal electrode conductive paste, including metal powder particles, a binder, and an organic solvent, may be printed on the ceramic green sheet to a predetermined thickness using a screen-printing method or a gravure-printing method, thereby forming an internal electrode pattern.

Thereafter, the ceramic green sheet having the internal electrode pattern printed thereon may be peeled off from the carrier film, and a predetermined number of ceramic green sheets may be laminated and pressed to form a ceramic laminate. In order to form the cover portions 112 and 113 after sintering, a predetermined number of ceramic green sheets in which no internal electrode pattern is formed may be laminated on an upper portion and a lower portion of the ceramic laminate. Thereafter, the ceramic laminate may be cut to have a predetermined chip size, and the cut chip may be sintered to form a body 110. Sintering may be performed, for example, under an H₂O/H₂/N₂ atmosphere in 1.0% H₂/99.0% N₂ to 3.5% H₂/96.5% N₂ at a temperature of 1000° C. or higher and 1400° C. or lower for 1 hour to 3 hours.

Subsequently, external electrodes 131 and 132 may be formed. For example, when base electrode layers 131a and 132a include a sintered electrode layer, the body 110 may be dipped into an external electrode conductive paste including metal powder particles, glass frit, a binder, and an organic solvent, and the external electrode conductive paste may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and cured by heat treatment at a temperature of 250° C. to 550° C. to form the resin electrode layer.

In addition, plating layers 131b and 132b may be formed on the base electrode layers 131a and 132a by additionally performing an electrolytic plating method and/or an electroless plating method.

ΔV may be determined by various factors, such as a size of the ceramic powder particle, the number of dielectric grains included in the dielectric layer 111, or a type and concentration of a defect included in the dielectric layer 111. ΔV may be reduced, for example, as a concentration of a defect present in the dielectric layer 111 decreases.

The concentration of the defect may be determined by various factors, such as types or contents of the first to third sub-ingredient powder particles, purity of the ceramic powder particles, uniformity of chemical composition of the ceramic powder particles, the uniformity of sizes of the ceramic powder particles, and/or milling time.

### EXPERIMENTAL EXAMPLES

Example embodiments will be described in more detail below with reference to experimental examples. However, the present disclosure is not limited to the experimental examples, which are provided only to facilitate a specific understanding of the present disclosure.

A sample chip having a size of 0603 (length: about 0.6 mm, width: about 0.3 mm, thickness: about 0.3 mm) was prepared by the above-described manufacturing method. Thereafter, an L-T cross-section of the sample chip, obtained by polishing the sample chip up to a central portion in a width direction of the sample chip, was exposed. In the L-T cross-section, a 5 μm×5 μm region of a central region in thickness and length directions of a capacitance formation portion Ac was analyzed using Park systems NX-10 (analysis mode: Kelvin probe force microscopy, cantilever: NSC36/Cr—Au AFM probe, applied voltage: 1 V) to obtain a KPFM surface potential map.

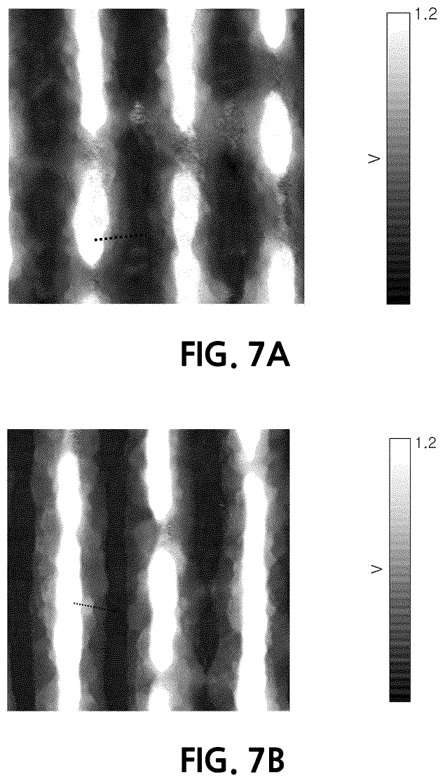

FIG. 7A is a KPFM surface potential map of a capacitance formation portion of Example 1. FIG. 7B is a KPFM surface potential map of a capacitance formation portion of Comparative Example 1. In FIGS. 7A and 7B, a brightest region may be an internal electrode to which a positive voltage is applied, a darkest region may be an internal electrode to which a negative voltage is applied, and a region disposed therebetween may be a dielectric layer.

Subsequently, a line profile, obtained by analyzing a surface potential of a dielectric layer along a measurement line of FIGS. 7A and 7B, was derived, from which, a surface potential difference (ΔV) between one surface and the other surface of the dielectric layer, opposing each other in a thickness direction, was calculated and indicated in Table 1 below.

Thereafter, a differential graph obtained by first-order differentiating a graph illustrating the line profile was derived. A maximum value LEV, among local extreme values appearing in a position corresponding to a central portion of the dielectric layer in the differential graph, was calculated and indicated in Table 1 below. Example 2, Example 3, Comparative Example 2, and Comparative Example 3 were also measured in the same manner and indicated in Table 1 below.

Subsequently, an accelerated lifetime test (HALT) was conducted for the examples and comparative examples. The HALT was performed under conditions of 125° C., 9.45 V, and 48 hours, from which, a mean time to failure (MTTF) was calculated and indicated in Table 1 below.

TABLE 1

| Classification | ΔV (V) | LEV (V/μm) | MTTF (hr) |
|---|---|---|---|
| Comparative | 0.77 | 70 | 4.4 |
| Example 1 | | | |
| Comparative | 0.86 | 65 | 4.4 |
| Example 2 | | | |
| Comparative | 0.75 | 59 | 11.2 |
| Example 3 | | | |
| Example 1 | 0.56 | 26 | 20.5 |
| Example 2 | 0.54 | 35 | 23.9 |
| Example 3 | 0.63 | 39 | 20.9 |

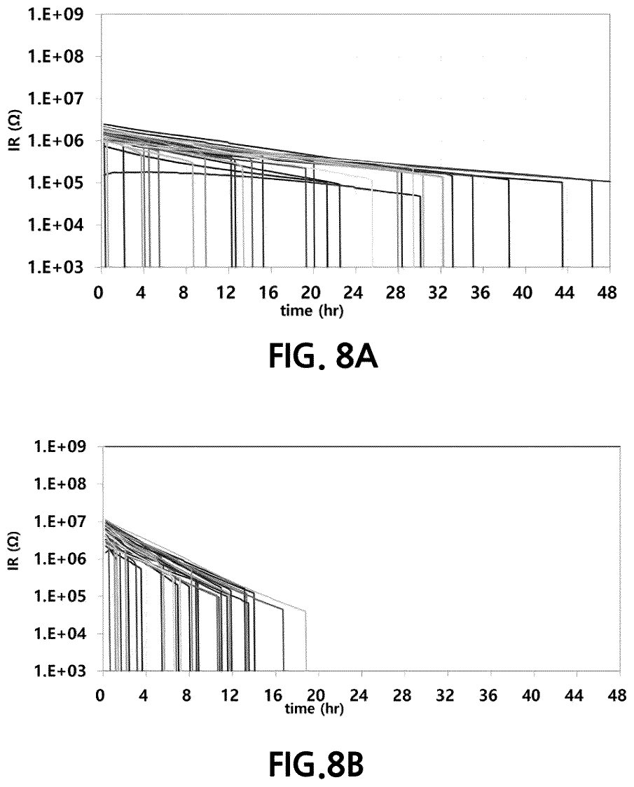

FIG. 8A is a graph illustrating a result of a HALT of Example 1. FIG. 8B is a graph illustrating a result of a HALT of Comparative Example 1. Referring to FIGS. 8A and 8B, an MTTF of Example 1 was about 20.5 hours, and a MTTF of Comparative Example 1 was about 4.4 hours. Accordingly, it was confirmed that Example 1 has excellent reliability, as compared to Comparative Example 1.

In addition, referring to Table 1, MTTFs of Examples 1 to 3 were all 20 hours or more, whereas MTTFs of Comparative Examples 1 to 3 were significantly lower than those of Examples 1 to 3.

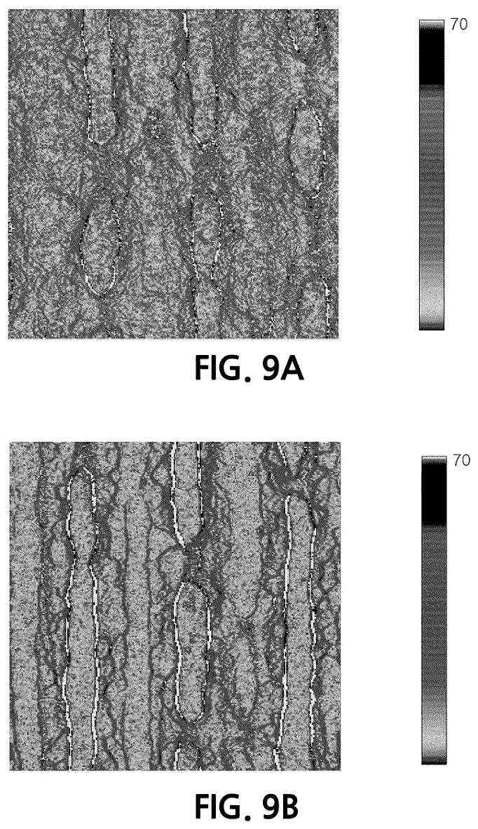

FIG. 9A is an electric field map of a capacitance formation portion of Example 1. FIG. 9B is an electric field map of a capacitance formation portion of Comparative Example 1. Referring to FIGS. 9A and 9B, it was confirmed that an electric field was uniformly distributed in a dielectric layer in Example 1. However, an electric field was excessively concentrated along a grain boundary of a dielectric layer in Comparative Example 1. Accordingly, it may be expected that degradation in insulation resistance occurred in the dielectric layer of Comparative Example 1.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the term “connected” may not only refer to “directly connected” but also “indirectly connected” by means of an adhesive layer or the like. The term “electrically connected” may include both a case in which elements are “physically connected” and a case in which elements are “not physically connected.” In addition, the terms “first,” “second,” and the like may be used to distinguish an element from another element, and may not imply any particular order and/or importance, or others in relation to the elements. In some cases, a first element may be referred to as a second element, and similarly, a second element may be referred to as a first element without departing from the scope of the example embodiments.

What is claimed is:

1. A multilayer electronic component comprising:
a body including a dielectric layer and internal electrodes alternately disposed with the dielectric layer in a thickness direction; and
an external electrode disposed on the body,
wherein a surface potential difference (ΔV) between a first surface and a second surface of the dielectric layer opposing each other in the thickness direction, as measured by a Kelvin probe force microscopy (KPFM), is 0.63 V or less.

2. The multilayer electronic component of claim 1, wherein a surface potential of the dielectric layer, as measured by the KPFM, gradually increases or gradually decreases from the first surface toward the second surface.

3. The multilayer electronic component of claim 1, wherein ΔV is 0.5 V or more and 0.63 V or less.

4. The multilayer electronic component of claim 1, wherein a differential graph obtained by first-order differentiating a graph illustrating a surface potential in each position of the dielectric layer, as measured by the KPFM, has at least one local extreme value in a position corresponding to a central portion of the dielectric layer.

5. The multilayer electronic component of claim 4, wherein the local extreme value is 40 V/μm or less.

6. The multilayer electronic component of claim 1, wherein
the dielectric layer includes a plurality of dielectric grains and a grain boundary disposed between adjacent dielectric grains among the plurality of dielectric grains, and
a differential graph obtained by first-order differentiating a graph illustrating a surface potential in each position of the dielectric layer, as measured by the KPFM, exhibits a local extreme value in a position corresponding to the grain boundary.

7. The multilayer electronic component of claim 1, wherein the dielectric layer includes two or more and three or less dielectric grains in the thickness direction.

8. The multilayer electronic component of claim 7, wherein an average size of the dielectric grains is 150 nm or more and 300 nm or less.

9. The multilayer electronic component of claim 1, wherein
the body includes first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction,
the external electrode is disposed on the third and fourth surfaces, and
surface potential measurement of the dielectric layer by the KPFM is performed on a cross-section in the thickness and the length direction of a central portion in the width direction of the multilayer electronic component.

10. The multilayer electronic component of claim 1, wherein an average thickness of the dielectric layer is 0.4 μm or less.

11. The multilayer electronic component of claim 1, wherein an average thickness of the internal electrodes is 0.4 μm or less.

12. The multilayer electronic component of claim 1, wherein a surface potential of the dielectric layer, as measured by the KPFM, gradually increases from the first surface toward the second surface.

13. The multilayer electronic component of claim 1, wherein a surface potential of the dielectric layer, as measured by the KPFM, gradually decreases from the first surface toward the second surface.
